(19) United States
(12) Patent Application Publication
(10) Pub. No.: US 2017/0124251 A1
(43) Pub. Date: May 4, 2017

(54) ESTIMATING MULTIPLE PARENTS FROM A MATRIX OF F1 HYBRID PROGENY

(71) Applicant: International Business Machines Corporation, Armonk, NY (US)

(72) Inventors: Laxmi P. Parida, Mohegan Lake, NY (US); Filippo Utro, White Plains, NY (US)

(21) Appl. No.: 14/965,350

(22) Filed: Dec. 10, 2015

Related U.S. Application Data
(63) Continuation of application No. 14/930,840, filed on Nov. 3, 2015.

(51) Int. Cl. G06F 19/18; G06F 17/50

(52) U.S. Cl. CPC G06F 19/18; G06F 17/50

(57) ABSTRACT

Embodiments are directed to a computer-based system for analyzing genotype data of a set of multiple progeny to estimate information about unknown parents of the multiple progeny. The system includes a memory and a processor system communicatively coupled to the memory. The processor system is configured to receive data representing markers of each genotype of each of the multiple progeny, compare the data to identify compatible genotypes having compatible markers, and label the compatible genotypes as having at least one parent in common.

### DOMESTIC PRIORITY

The present application claims priority to U.S. Non-provisional application Ser. No. 14/930,840 filed on Nov. 3, 2015 titled “ESTIMATING MULTIPLE PARENTS FROM A MATRIX OF F1 HYBRID PROGENY,” assigned to the assignee hereof and expressly incorporated by reference herein.

### BACKGROUND

The present disclosure relates in general to the use of computational biology in the study and analysis of genetic populations. More specifically, the present disclosure relates to systems and methodologies for analyzing the known genotypes of a sparse number of hybrid F1 progeny in order to reliably estimate the unknown genotypes of their parents.

A gene is a locus or region of DNA that is the molecular unit of heredity. Genes are made up of molecules inside the nucleus of a cell that are strung together in such a way that the sequence carries information. This information determines how living organisms inherit phenotypic traits (i.e., features), which are determined by the genes they received from their parents, grandparents and so on, going back through generations. For example, offspring produced by sexual reproduction usually look similar to each of their parents because they have inherited some of each of their parents' genes. The transmission of genes to an organism's offspring is the basis for inheritance of phenotypic traits. Most biological traits are under the influence of many different genes, as well as gene-environment interactions. Some genetic traits are instantly visible, such as eye color or number of limbs, and some are not, such as blood type, risk for specific diseases, or any one of the thousands of basic biochemical processes that comprise life.

Genetics is the study of how genes work. Genetics identifies which features are inherited, and explains how these features pass from generation to generation. In addition to inheritance, genetics studies how genes are turned on and off to control what substances are made in a cell (i.e., gene expression) and how a cell divides. Accordingly, genetics is used extensively in animal and plant breeding to control inherited traits. In early plant breeding, farmers controlled inherited traits by simply selecting food plants with particular desirable characteristics, and then employing these as progenitors for subsequent generations, resulting in an accumulation of valuable traits over time. Using genetics, plant and animal breeders can now produce desired progeny characteristics is less time and with more accuracy and control.

A filial-1 (F1) hybrid is the first filial generation of offspring of distinctly different parental types. Accordingly, crossing two genetically different plants produces an F1 hybrid seed. This can happen naturally and includes hybrids between species. For example, peppermint is a sterile F1 hybrid of watermint and spearmint. The F1 hybrid offspring of distinctly different parental types produce a new, uniform phenotype with a combination of characteristics from the parents. In fish breeding, those parents frequently are two closely related fish species, while in plant and animal genetics the parents usually are two inbred lines. The genes of individual plant or animal F1 hybrid offspring of homozygous pure lines display limited variation making their phenotype uniform and therefore attractive for mechanical operations and easing fine population management. Once the characteristics of the cross are known, repeating the same cross yields exactly the same result.

Selective breeding requires extensive study and analysis of an organism's genotype, which is the internally coded, inheritable information carried by all living organisms. Genotype information is used as a “blueprint” or set of instructions for building and maintaining a living creature. These instructions are found within almost all cells and are they are written in a coded language known generally as the “genetic code.” Genetic code instructions are copied at the time of cell division or reproduction (i.e., meiosis) and are passed from one generation to the next through inheritance. Genetic code instructions are intimately involved with all aspects of the life of a cell or an organism. They control everything from the formation of protein macromolecules to the regulation of metabolism and synthesis.

An important source of information about an organism's genotype is derived from the genotype of the organism's parents. However, in many scenarios the parents of a progeny are unknown or unavailable, so valuable information about the specific genotype of the parents cannot be obtained. For example, a plant researcher or other entity may wish to study a population of plants having traits that are of interest, but may not know or have access to the parents. In another scenario, a plant breeder may wish to determine whether a particular seed is the progeny of a parent in which the breeder has a proprietary interest. Accordingly, it would be beneficial to provide systems and methodologies for analyzing the known genotype of progeny in order to reliably estimate the unknown genotype of its parents.

### SUMMARY

Embodiments are directed to a computer-based system for analyzing genotype data of a set of multiple progeny to estimate information about unknown parents of the multiple progeny. The system includes a memory and a processor system communicatively coupled to the memory. The processor system is configured to receive data representing markers of each genotype of each of the multiple progeny, compare the data to identify compatible genotypes having compatible markers, and label the compatible genotypes as having at least one parent in common.

Embodiments are further directed to a computer-implemented method for analyzing genotype data of a set of multiple progeny to estimate information about unknown parents of the multiple progeny. The method includes receiving, using a processor system, data representing markers of each genotype of each of the multiple progeny. The method further includes comparing, using the processor system, the data to identify compatible genotypes having compatible markers, and labeling, using the processor, the compatible genotypes as having at least one parent in common.

Embodiments are further directed to a computer program product for analyzing genotype data of a set of multiple progeny to estimate information about unknown parents of the multiple progeny. The computer program product includes a computer readable storage medium having program instructions embodied therewith, wherein the computer readable storage medium is not a transitory signal per se, the program instructions readable by a processor system to cause the processor system to perform a method. The method includes receiving, using the processor system, data representing markers of each genotype of each of the multiple progeny. The method further includes comparing, using the processor system, the data to identify compatible genotypes having compatible markers, and labeling, using the processor system, the compatible genotypes as having at least one parent in common.

Additional features and advantages are realized through the techniques described herein. Other embodiments and aspects are described in detail herein. For a better understanding, refer to the description and to the drawings.

### BRIEF DESCRIPTION OF THE DRAWINGS

The subject matter which is regarded as the present disclosure is particularly pointed out and distinctly claimed in the claims at the conclusion of the specification. The foregoing and other features and advantages are apparent from the following detailed description taken in conjunction with the accompanying drawings in which:

FIG. 1 depicts an exemplary computer system capable of implementing one or more embodiments of the present disclosure;

FIG. 2 depicts a diagram illustrating the relationship between chromosomes, DNA and genes;

FIG. 3 depicts a system and process flow illustrating how a set of parents can be combined to generate a set of offspring;

FIG. 4 depicts a target result of the present disclosure, wherein known genotype information of a known set of progeny is analyzed in accordance with one or more embodiments to estimate previously unknown genotype information of previously unknown parents of the progeny;

FIG. 5 depicts known genotype information of a known set of progeny according to one or more embodiments;

FIG. 6 depicts a cross matrix in accordance with one or more embodiments;

FIG. 7 depicts a methodology in accordance with one or more embodiments;

FIG. 8 depicts additional details of the methodology shown in FIG. 7;

FIG. 9 depicts additional details of the methodology shown in FIG. 7;

FIG. 10 depicts additional details of the methodology shown in FIG. 7;

FIG. 11 depicts a problem formulation in accordance with one or more embodiments;

FIG. 12 depicts details of Step 1 in accordance with one or more embodiments;

FIG. 13 depicts details of Step 2 in accordance with one or more embodiments;

FIG. 14 depicts additional details of Step 2 in accordance with one or more embodiments;

FIG. 15 depicts details of Step 3 in accordance with one or more embodiments;

FIG. 16 depicts details of Step 4 in accordance with one or more embodiments;

FIG. 17 depicts details of Step 5 in accordance with one or more embodiments; and

FIG. 18 depicts a computer program product in accordance with one or more embodiments.

In the accompanying figures and following detailed description of the disclosed embodiments, the various elements illustrated in the figures are provided with three or four digit reference numbers. The leftmost digit(s) of each reference number corresponds to the figure in which its element is first illustrated.

### DETAILED DESCRIPTION

Various embodiments of the present disclosure will now be described with reference to the related drawings. Alternate embodiments may be devised without departing from the scope of this disclosure. It is noted that various connections are set forth between elements in the following description and in the drawings. These connections, unless specified otherwise, may be direct or indirect, and the present disclosure is not intended to be limiting in this respect. Accordingly, a coupling of entities may refer to either a direct or an indirect connection.

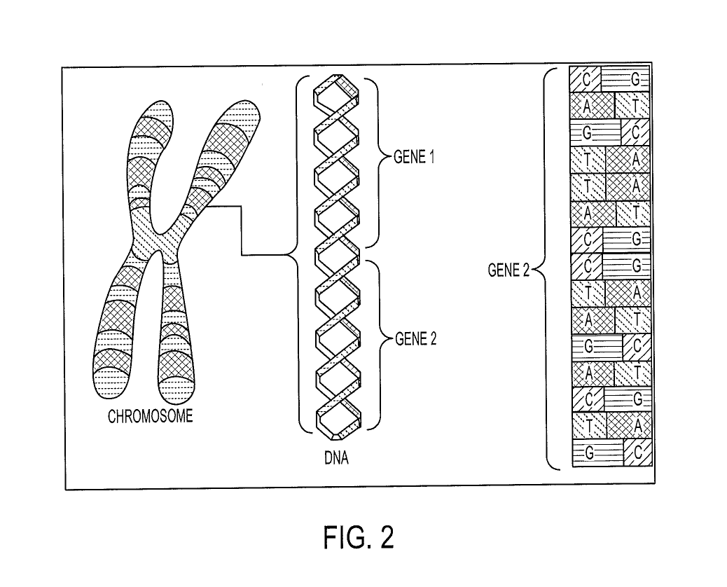

The chromosomes of a cell are in the cell nucleus. The relationship between chromosomes, DNA and genes is shown in FIG. 2. Chromosomes contain many genes and carry the genetic information of the organism. Chromosomes are made up of DNA and protein combined as chromatin. All animal cells have a fixed number of chromosomes in their body cells, which exist in homologous pairs. Each chromosome pair is described as a diploid, and each individual chromosome is described as a haploid.

Different animals have different numbers of chromosomes. For example, there are 23 chromosome pairs (i.e., 46 total) in a human, including a pair of sex hormones. Human progeny receives a set of 23 chromosomes from their father and a matching set of 23 chromosomes from their mother. To produce each parent's 23 sex cells (gametes) for donation to the progeny, the stem cells go through a different division process called meiosis, which reduces the parent's 23 chromosome pairs (i.e., diploids) to 23 individual chromosomes (i.e., haploids), which combine with the other parent's 23 pair through fertilization to produce the new set of 23 pairs of the progeny.

The terms homozygous, heterozygous and hemizygous are used to describe the genotype of a diploid organism at a single locus on the DNA. Homozygous describes a genotype consisting of two identical alleles at a given locus, and heterozygous describes a genotype consisting of two different alleles at a locus. Hemizygous describes a genotype consisting of only a single copy of a particular gene in an otherwise diploid organism.

As previously noted herein, selective breeding requires extensive study and analysis of an organism's genotype, which is the internally coded, inheritable information carried by all living organisms. Genotype information is used as a “blueprint” or set of instructions for building and maintaining a living creature. These instructions are found within almost all cells and are they are written in a coded language known generally as the “genetic code.” Genetic code instructions are copied at the time of cell division or reproduction (i.e., meiosis) and are passed from one generation to the next through inheritance. Genetic code instructions are intimately involved with all aspects of the life of a cell or an organism. They control everything from the formation of protein macromolecules to the regulation of metabolism and synthesis.

An important source of information about an organism's genotype is derived from the genotype of the organism's parents. However, in many scenarios the parents of a progeny are unknown or unavailable, so valuable information about the specific genotype of the parents cannot be obtained. For example, a plant researcher or other entity may wish to study a population of plants having traits that are of interest, but may not know or have access to the parents. In another scenario, a plant breeder may wish to determine whether a particular seed is the progeny of a parent in which the breeder has a proprietary interest. Accordingly, it would be beneficial to provide systems and methodologies for analyzing the known genotype of progeny in order to reliably estimate the unknown genotype of its parents.

The present disclosure provides systems and methodologies for analyzing the genotype of progeny in order to reliably estimate the genotype of parents. In one or more embodiments, systems and methodologies are provided that analyze the genotypes of a sparse number of hybrid F1 progeny in order to reliably estimate the genotypes of their parents.

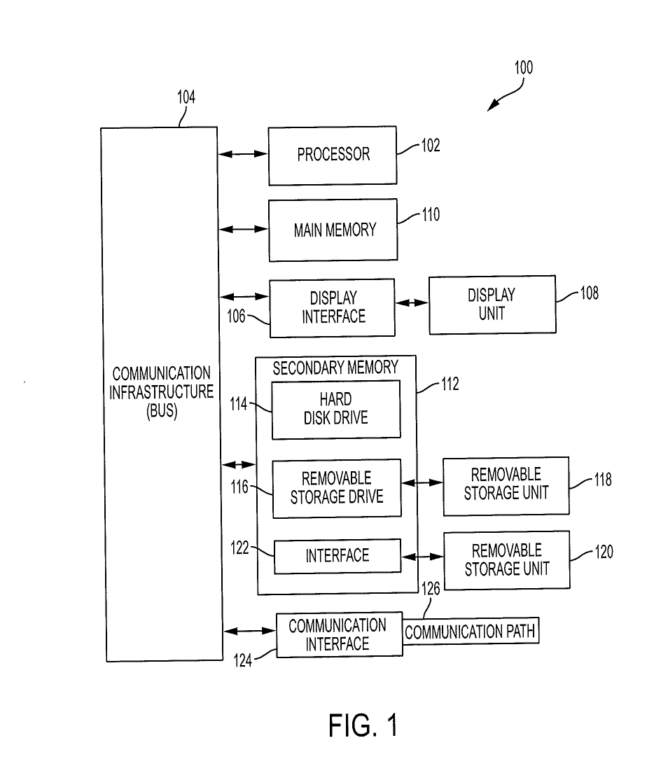

Turning now to a more detailed description of the present disclosure, FIG. 1 illustrates a high level block diagram showing an example of a computer-based system 100 useful for implementing one or more embodiments. Although one exemplary computer system 100 is shown, computer system 100 includes a communication path 126, which connects computer system 100 to additional systems and may include one or more wide area networks (WANs) and/or local area networks (LANs) such as the Internet, intranet(s), and/or wireless communication network(s). Computer system 100 and additional system are in communication via communication path 126, e.g., to communicate data between them.

Computer system 100 includes one or more processors, such as processor 102. Processor 102 is connected to a communication infrastructure 104 (e.g., a communications bus, cross-over bar, or network). Computer system 100 can include a display interface 106 that forwards graphics, text, and other data from communication infrastructure 104 (or from a frame buffer not shown) for display on a display unit 108. Computer system 100 also includes a main memory 110, preferably random access memory (RAM), and may also include a secondary memory 112. Secondary memory 112 may include, for example, a hard disk drive 114 and/or a removable storage drive 116, representing, for example, a floppy disk drive, a magnetic tape drive, or an optical disk drive. Removable storage drive 116 reads from and/or writes to a removable storage unit 118 in a manner well known to those having ordinary skill in the art. Removable storage unit 118 represents, for example, a floppy disk, a compact disc, a magnetic tape, or an optical disk, etc. which is read by and written to by removable storage drive 116. As will be appreciated, removable storage unit 118 includes a computer readable medium having stored therein computer software and/or data.

In alternative embodiments, secondary memory 112 may include other similar means for allowing computer programs or other instructions to be loaded into the computer system. Such means may include, for example, a removable storage unit 120 and an interface 122. Examples of such means may include a program package and package interface (such as that found in video game devices), a removable memory chip (such as an EPROM, or PROM) and associated socket, and other removable storage units 120 and interfaces 122 which allow software and data to be transferred from the removable storage unit 120 to computer system 100.

Computer system 100 may also include a communications interface 124. Communications interface 124 allows software and data to be transferred between the computer system and external devices. Examples of communications interface 124 may include a modem, a network interface (such as an Ethernet card), a communications port, or a PCM-CIA slot and card, et cetera. Software and data transferred via communications interface 124 are in the form of signals which may be, for example, electronic, electromagnetic, optical, or other signals capable of being received by communications interface 124. These signals are provided to communications interface 124 via communication path (i.e., channel) 126. Communication path 126 carries signals and may be implemented using wire or cable, fiber optics, a phone line, a cellular phone link, an RF link, and/or other communications channels.

In the present disclosure, the terms “computer program medium,” “computer usable medium,” and “computer readable medium” are used to generally refer to media such as main memory 110 and secondary memory 112, removable storage drive 116, and a hard disk installed in hard disk drive 114. Computer programs (also called computer control logic) are stored in main memory 110 and/or secondary memory 112. Computer programs may also be received via communications interface 124. Such computer programs, when run, enable the computer system to perform the features of the present disclosure as discussed herein. In particular, the computer programs, when run, enable processor 102 to perform the features of the computer system. Accordingly, such computer programs represent controllers of the computer system.

Computational biology involves the development and application of data-analytical and theoretical methods, mathematical modeling and computational simulation techniques to the study of biological, behavioral, and social systems. The field is broadly defined and includes foundations in computer science, applied mathematics, animation, statistics, biochemistry, chemistry, biophysics, molecular biology, genetics, genomics, ecology, evolution, anatomy, neuroscience, and visualization.

Computer system 100 may be used in accordance with the present disclosure to understand the evolutionary and genetic consequences of complex processes. Computer-based tools often involve a range of components, including modules for preparation, extraction and conversion of data, program codes that perform experiment-related computations, and scripts that join the other components and make them work as a coherent system that is capable of displaying desired behavior. For example, a DNA sequencer is a scientific instrument used to automate the DNA sequencing process. Given a sample of DNA, a DNA sequencer is used to determine the order of the four bases, namely G (guanine), C (cytosine), A (adenine) and T (thymine). This sequence is then reported as a text string, called a read. Some DNA sequencers can be also considered optical instruments as they analyze light signals originating from fluorochromes attached to nucleotides.

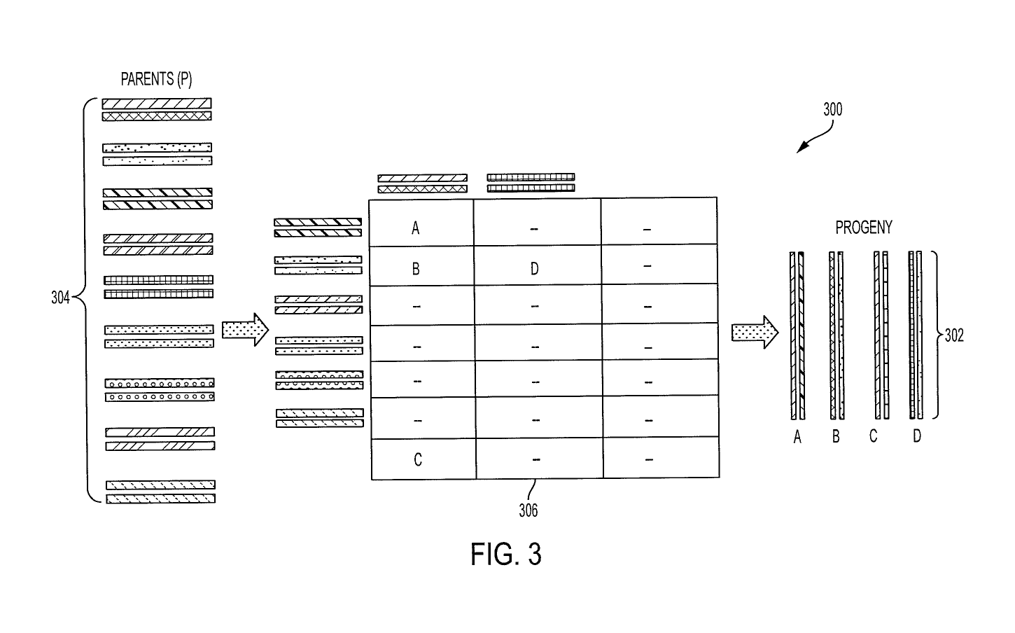

FIG. 3 depicts a system 300 and associated process flow that may be utilized to identify how a genotype 302 of a set of progeny A, B, C, D is generated from a genotype 304 of a set of parents, P. The genotypes 304 of “Parents” P include chromosome pairs, which are shown in FIG. 3 as horizontal bars. The genotypes 302 of progeny A, B, C, D also include chromosome pairs, which are shown in FIG. 3 as vertical bars. The solution to this problem is known in the art. The operations performed by system 300 to identify progeny genotype 302 from known parent genotype 304 include developing cross (i.e., mating) matrix 306, “splitting” the chromosomes of parent genotype 304 for each parent and placing them along “outside” axes of cross matrix 306, and determining genotypes 302 of progeny A, B, C, D by filling in cross matrix 306.

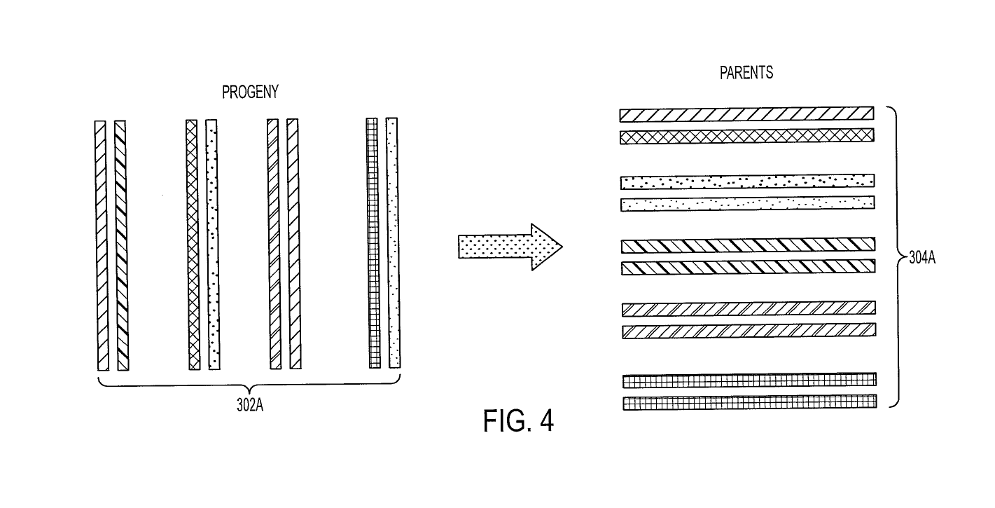

As shown in FIG. 4, in contrast to system 300, the present disclosure addresses the more challenging problem of estimating a previously unknown parent genotype 304A from a known progeny genotype 302A, wherein the chromosome pairs of progeny genotype 302A are shown by vertical bars, and wherein the chromosome pairs of parent genotypes 304A are shown by horizontal bars.

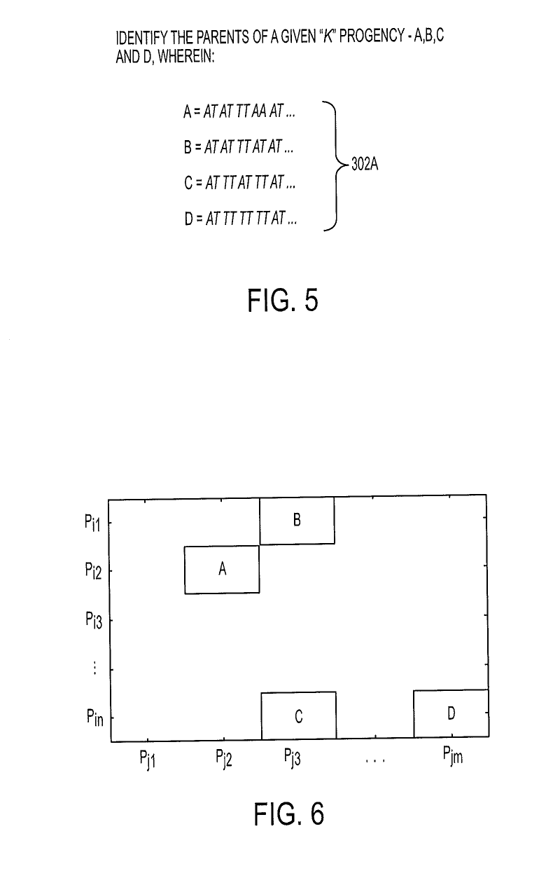

As shown in FIG. 5, the problem addressed by the present disclosure may be more specifically stated as estimating the unknown parents of a given “k” progeny, A, B, C, D, wherein genotypes 302A of progeny A, B, C, D is known. As previously noted herein, selective breeding requires extensive study and analysis of an organism's genotype, and an important source of information about an organism's genotype is derived from the genotype of the organism's parents. However, in many scenarios the parents of a progeny are unknown or unavailable, so valuable information about the specific genotype of the parents cannot be obtained. For example, a plant researcher or other entity may wish to study a population of plants having traits that are of interest, but may not know or have access to the parents. In another scenario, a plant breeder may wish to determine whether a particular seed is the progeny of a parent in which the breeder has a proprietary interest. Accordingly, the present disclosure provides systems and methodologies for analyzing the known genotype of progeny in order to reliably estimate the unknown genotype of its parents.

As shown in FIG. 6, one or more embodiments of the present disclosure make two assumptions. First, a large number (e.g., about 70%-90% of the full matrix) of male and female parents are crossed to obtain a relatively few (e.g., about 10%-30% of the full matrix) F1 hybrid progeny. Second, the parent chromosomes are near-homozygous with only a few heterozygous loci.

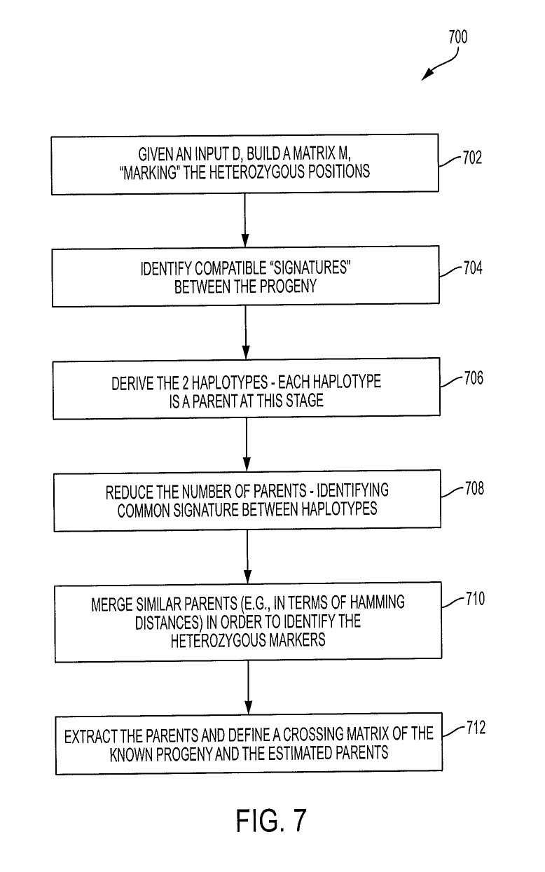

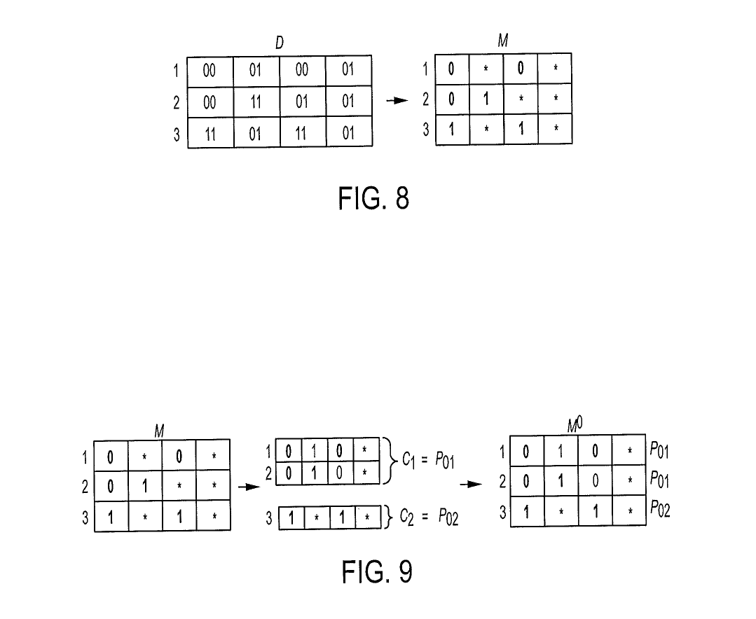

FIG. 7 depicts a methodology 700 for estimating genotypes of previously unknown parents based on an analysis of known genotypes of known progeny according to one or more embodiments. Methodology 700 begins at block 702 by, given an input D, building a matrix M that “marks” the heterozygous positions. Block 704 identifies compatible “signatures” between the progeny. Block 706 derives the 2 haplotypes, wherein each haplotype is a parent at this stage. Block 708 reduces the number of parents by identifying common signatures between haplotypes. Block 710 merges similar parents (e.g., in terms of Hamming distances) in order to identify the heterozygous markers. Block 712 extracts the parents and defines a crossing matrix of the known progeny and the estimated parents. Additional details of methodology 700 are described below in connection with descriptions of FIGS. 8-10.

FIG. 8 depicts additional details of block 702 of methodology 700. Matrix D is generated by a DNA sequencer (not shown), which analyzes each progeny (1, 2, 3) to determine its genotype. In matrix D, each row corresponds to a progeny (1, 2, 3), and each column corresponds to a marker in the chromosome/genome of the progeny. In matrix D, there are three progeny and four markers/columns for each progeny. Geneticists use diagrams such as matrix D in FIG. 8 and cross matrix 306 in FIG. 3 to describe inheritance. A gene is typically represented in the matrix by one or a few letters. For one specific trait, two letters are used to represent the genotype, one letter for the chromosome inherited from the female parent and the letter for the chromosome inherited from the male parent. A capital letter represents the dominant form of a gene (allele), and a lowercase letter represents the recessive form of the gene (allele). In computational biology, the letters are typically encoded as numbers, either “0” or “1,” as shown by matrix D. According, the genotype for progeny 1 is the sequence of markers or chromosome pairs in row 1, namely 00, 01, 00 and 01.

Referring still to FIG. 8, when provided with matrix D as an input, block 702 builds a new matrix M that is populated with an abstract encoding of the progeny genotypes of matrix D. In matrix M, if for a given marker two parents donated the same genotype, the marker is encoded in matrix M as a single digit. For example, if both parents provided a “0,” that marker is encoded in matrix M as a “0.” If both parents provided a “1,” that marker is encoded in matrix M as a “1.” If one parent provided a “0” and the other parent provided a “1,” that marker is encoded with an “*” to denote a wildcard or “we don't know yet.”

The remaining operations in methodology 700 attempt to determine the appropriate values for the markers holding an “*.” FIG. 9 illustrates additional details of how block 704 may be implemented. As shown in FIG. 9, matrix M is diverged into two matrices C₁, C₂, and then converged back to a single new matrix M⁰. This is done by stepping through each column and identifying compatibility among the markers. Progeny 1 and 2 are grouped as C₁ (or parent P₀₁), because the “signature” (i.e., “row” of markers) of progeny 1 is compatible with the “signature” of progeny 2. Specifically, in column 1, “0” is compatible with “0,” in column 2, “*” is compatible with “1,” in column 3, “0” is compatible with “*,” and in column 4, “*” is compatible with “*.” Thus, it can be inferred that progeny 1 and progeny 2 have at least one parent P₀₁ in common in order to take into account the possibility that one parent crossed with multiple other parents to generate progeny. In merged C₁, it is assumed for this stage of the analysis that the “*” in column 2 is the same as “1,” and that the “*” in column 3 is the same as the “0.” Neither progeny 1 nor progeny 2 can be grouped with progeny 3 because their signatures are not compatible. Thus, progeny 3 cannot share a parent with either progeny 1 or progeny 2, so progeny 3 is grouped alone as C₂ (or parent P₀₂), and there is no opportunity to change any “*” for progeny 3 at this stage of the analysis.

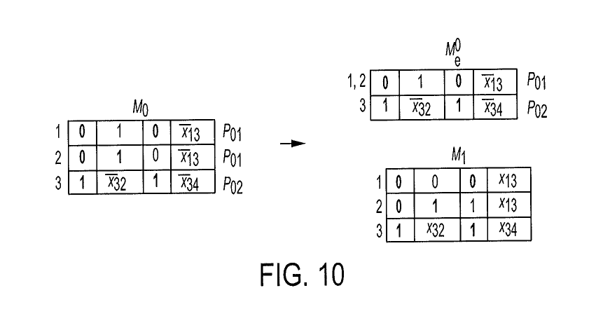

FIG. 10 illustrates additional details of how block 706 may be implemented. The 2 haploids (one for each parent) are derived by diverging matrix M₀ into matrix M_{0c}, and matrix M₁. M_{0c} corresponds to one set of parents, P₀₁ and P₀₂, and M₁ corresponds to another set of parents. It was previously assumed that Progeny 1 and 2 share at least one parent, P₀₁. Rows 1 and 2 of matrix M₁ identify the non-common parent between progeny 1 and progeny 1. Referring back to matrix D of FIG. 8, it is seen that for progeny 1, in column 2, one parent contributed a “1” and one parent contributed a “0.” Similarly, for progeny 1, in column 3, one parent contributed a “0” and one parent contributed a “1.” For progeny 2, in column 2, one parent contributed a “1” and one parent contributed a “0.” Similarly, for progeny 2, in column 3, one parent contributed a “0” and one parent contributed a “1.” The “*” of matrix M⁰ shown in FIG. 9 is replaced with functions in the matrices shown in FIG. 10.

Blocks 708 and 710 in effect apply the operations described in blocks 704, 706 and distance (e.g. Hamming) calculations to the output of block 706 to further reduce the number of parents by identifying common signatures between the haploids (e.g., M_{0c} and M₁) in order to cluster the number of parents. This takes into account the fact that, for plants, a given plant can function as either the male or the female. Block 710 extracts the parents and defines a crossing matrix, similar to the crossing matrix 306 shown in FIG. 3.

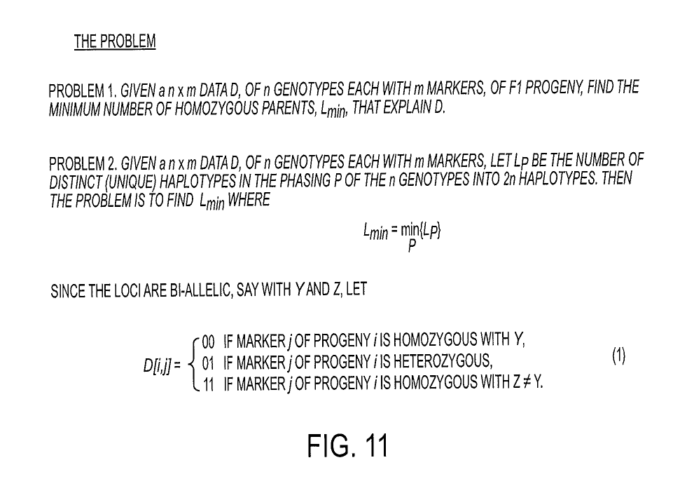

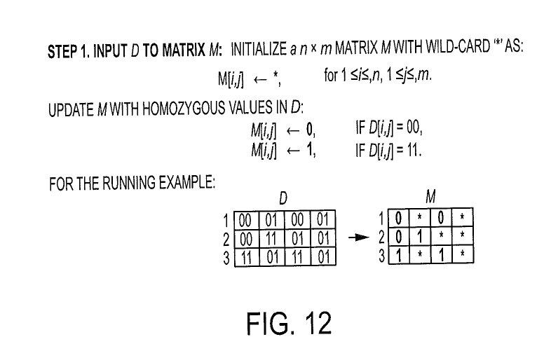

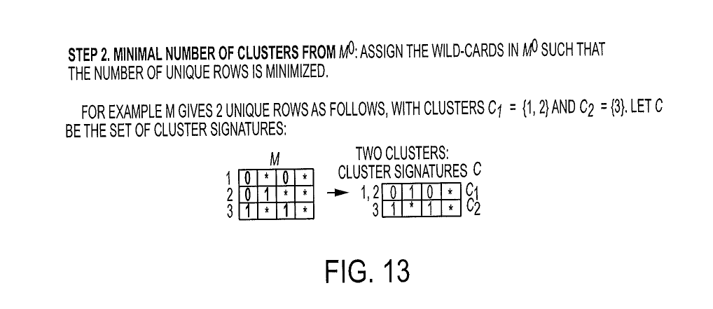

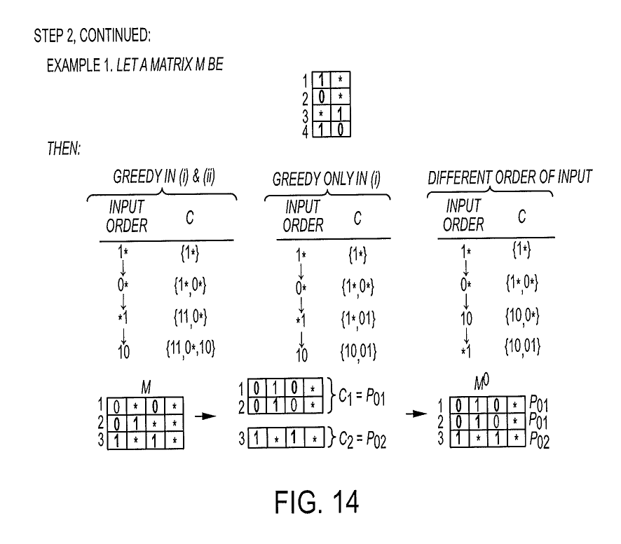

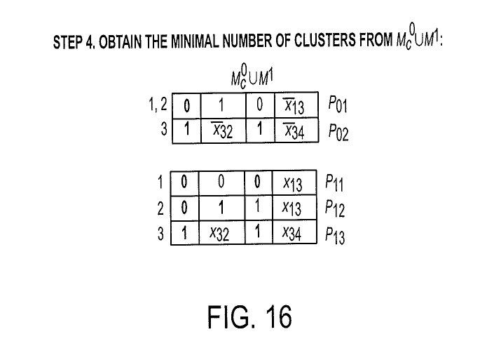

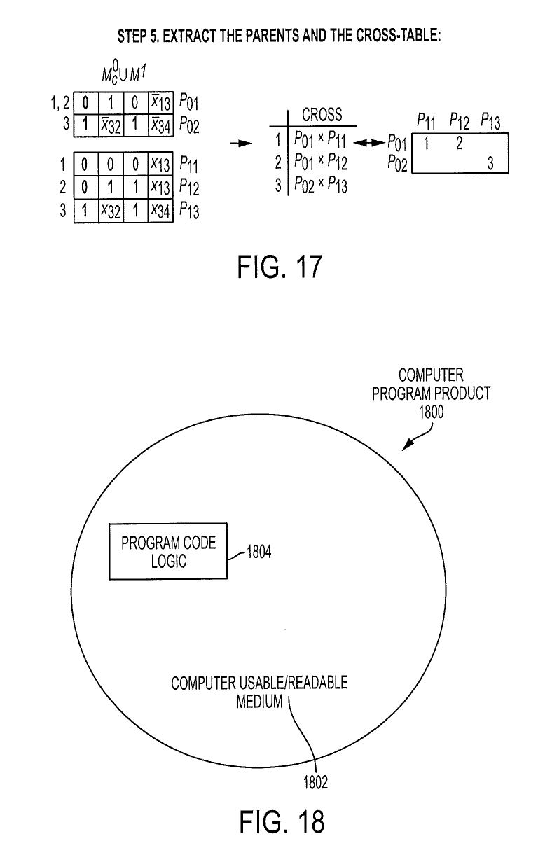

A more detailed embodiment of the present disclosure is now provided with reference to FIGS. 11 to 17. FIG. 11 frames a problem addressed by Steps 1 to 5 illustrated in FIGS. 12 to 17. The methodology illustrated in FIGS. 12 to 17 includes the following steps: Step 1, derive M from input D; Step 2, obtain the minimal number of clusters from M₀; Step 3, derive M_{0c}, M¹ from M⁰; Step 4, obtain the minimal number of clusters from M_{0c} ∪ M¹; and Step 5, extract the parents and the cross-table.

As depicted in FIG. 11, the embodiment of FIGS. 12 to 17 addresses a problem wherein an unknown (large) number of male homozygous parents and an unknown (large) number of female homozygous parents are crossed to produce F1 progeny. If there were Lₘ male parents and L_{f} female parents, the complete matrix of crosses would give a matrix of Lₘ×L_{f} progeny. The number of given progeny “n” is much less than the crossing matrix (i.e., about 10%-30% of the full matrix). The task performed by the embodiment of FIGS. 12-17 is to estimate the parents from the genotypes of this small number of progeny “n.” The parents are assumed to be homozygous. However, it is possible that the parents could be heterozygous in a few marker locations.

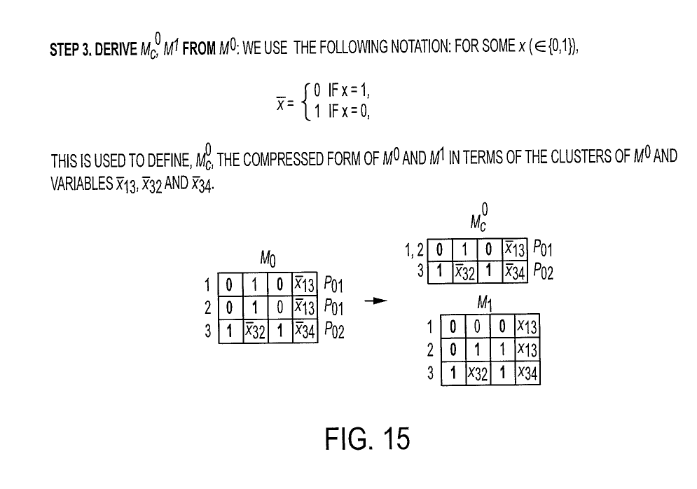

Under a scenario in which there are homozygous as well as heterozygous loci, M⁰ and M¹ are identical in all of the homozygous positions, and the remaining loci are “0s” in M⁰ and “1s”in M¹. Under this scenario, there is no need to store two Ms but instead a single M may be stored as discussed in the connection with the methodology illustrated in FIGS. 12 to 17. Next, “0s” and “1s” are assigned to M such that the number of parental haplotypes is minimized. Thus, a cluster (e.g., Step 3 shown in FIG. 15) corresponds to a single such parental haplotype. In the solution, all the parents must be fully homozygous. The input genotypes are matrix M shown in FIG. 8, which is obtained from a cross of parents P₀ᵢ×P₁ⱼ. Matrix M is preprocessed to collapse all identical rows and identical columns to obtain n×m matrix D.

Thus, it can be seen from the foregoing description and illustration that one or more embodiments of the present disclosure provide technical features and benefits. The present disclosure provides systems and methodologies for analyzing the genotype of progeny in order to reliably estimate the genotype of parents. In one or more embodiments, systems and methodologies are provided that analyze the genotypes of a sparse number of hybrid F1 progeny in order to reliably estimate the genotypes of their parents. An important source of information about an organism's genotype is derived from the genotype of the organism's parents. However, in many scenarios the parents of a progeny are unknown or unavailable, so valuable information about the specific genotype of the parents cannot be obtained. For example, a plant researcher or other entity may wish to study a population of plants having traits that are of interest, but may not know or have access to the parents. In another scenario, a plant breeder may wish to determine whether a particular seed is the progeny of a parent in which the breeder has a proprietary interest. The present disclosure provides systems and methodologies for analyzing the known genotype of progeny in order to reliably estimate the unknown genotype of its parents.

Referring now to FIG. 18, a computer program product 1800 in accordance with an embodiment that includes a computer readable storage medium 1802 and program instructions 1804 is generally shown.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

It will be understood that those skilled in the art, both now and in the future, may make various improvements and enhancements which fall within the scope of the claims which follow.

What is claimed is:

1. A computer-implemented method for analyzing genotype data of a set of multiple progeny to estimate information about unknown parents of the multiple progeny, the method comprising:
receiving, using a processor system, data representing markers of each genotype of each of the multiple progeny;
comparing, using the processor system, the data to identify compatible genotypes having compatible markers; and
labeling, using the processor, at least some of the compatible genotypes as having at least one parent in common.

2. The method of claim 1 further comprising labeling others of the compatible genotypes as having at least one parent not in common.

3. The method of claim 2 further comprising:
comparing the data to identify incompatible genotypes having incompatible markers; and
labeling the incompatible genotypes as not having any parent in common.

4. The method of claim 1 further comprising determining, based at least in part on the data, haploids contributed by the at least one parent in common.

5. The method of claim 2 further comprising determining, based at least in part on the data, haploids contributed by the at least one parent not in common.

6. The method of claim 2 further comprising:
receiving, using the processor system, first parent marker data representing markers of each genotype of the at least one parent in common;
comparing the first parent marker data to identify first parent compatible genotypes having compatible markers; and
labeling the first parent compatible genotypes as being the same parent.

7. The method of claim 6 further comprising:
receiving, using the processor system, second parent marker data representing markers of each genotype of the at least one parent not in common;
comparing the second parent marker data to identify second parent compatible genotypes having compatible markers; and
labeling the second parent compatible genotypes as being the same parent.
